(19) United States
(12) Patent Application Publication
(10) Pub. No.: US 2012/0304633 A1
(43) Pub. Date: Dec. 6, 2012

(54) INTENSIFIER OF HYDRAULIC POWER WITH RELY WITH MAINTENANCE OF THE REACHED POSITION AND FORCE

(76) Inventor: Carlo Maria Rozzi De Hieronymis, Marzabotto (IT)

(21) Appl. No.: 13/575,243

(22) PCT Filed: Feb. 22, 2011
(86) PCT No.: PCT/IB11/50724

§ 371 Date: Jul. 25, 2012

(30) Foreign Application Priority Data
Feb. 26, 2010 (IT) MO2010A000044

(51) Int. Cl. F15B 9/08

(52) U.S. Cl. 60/393

(57) ABSTRACT

The invention relates to a linear hydraulic actuator which incorporates inside it a piston which can be reciprocally actuated by means of a distributor and a feedback positioning and reversing device. If during its uniform linear travel the actuator meets a resistance or an obstacle, actuating the double-action piston reciprocally will enable the actuator to continue its stroke with intermittent motion and multiplied force without the mobile part of the actuator moving back from the previously reached position and until the obstacle has been overcome.

The present invention relates to a linear actuator with an integrated multiplier of hydraulic force with reset, suitable for being used to overcome resistances met along the path thereof as well as to exert strong closing thrusts or drive kinematic mechanisms requiring a high working force.

Electromechanical, pneumatic and hydraulic linear actuators, as well as both pneumatic and hydraulic pressure multipliers are known and used in various industrial sectors. All known types can perform a variety of functions, including that of overcoming resistance met along their path, but none are provided with a force multiplier located inside the cylinder stem itself, which can be reset even a number of times without either losing the reached position or the thrust force, so that the maximum force is again exerted from the previously reached position.

The linear actuator bearing the title “Intensifier of hydraulic power with reset”, described in patent application no. MO2009A000161 filed in Modena on Jun. 17, 2009 in the name of Rozzi De Hieronymis Carlo Maria, also presents the drawback that during the reset phase, under certain conditions, though it maintains the reached position so as to restart from the reached position, the thrust force may decrease, eventually even to zero; this second version of the intensifier guarantees not only maintenance of the reached position, but also the value of the reached thrust force.

The main object of the present invention is to make available to users an actuator in which the reciprocally mobile piston contained therein, which enables a multiplication of force, can be repeatedly reset without the actuator losing either the reached position or the thrust force, so that it will restart with the maximum force from this same already reached position.

A second object consists in that, without introducing any variants, it can be used:

a) as a pressure or thrust multiplier for pressing, cutting, shearing, riveting, coining, clamping, closing, etc.
b) as a linear actuator it can move, translate, position, etc.
objects and mechanical members and drive kinematic mechanisms.

Another object consists in that, outer dimensions being equal, actuators greatly differing from one another in terms of functional and technological characteristics can be realised.

Yet another object consists in that the control circuit and the power circuit can be customised according to the specific use for which the actuator is intended.

These and other objects are achieved by the device according to the invention, which comprises a fixed part homologous to the liner of a normal double-acting cylinder, a mobile part homologous to the stem, a mobile double-acting piston added inside the stem which can move reciprocally and which permits the multiplication of the force by feedback positioning through a pure proportional servo-control, and an hydraulic circuit, wherein the whole is characterised in that the said fixed part has the double function of liner for the piston and slide for the mobile part homologous to the stem, the said mobile part has the double function of stem and slide for the said piston, the said piston can be moved reciprocally by the said hydraulic circuit formed by suitable valves and relative distributor, the hydraulic circuit has the function of actuating the individual components of the intensifier according to user needs, means for fixing the actuator to a structure and means for connecting the mobile part to what has to be actuated, the whole formed and disposed in such a way as to configure a double-acting cylinder plus a single effect one concentric to each other, containing a double-acting concentric piston, whose reciprocal movement is independent and at each cycle (forward and back stroke) produces an increase in force and an intermittent advancing of the said mobile part when it has to overcome an obstacle.

Further characteristics and advantages of the invention will be more apparent from the description of some preferred, but not exclusive embodiments of the power intensifier illustrated by way of non-restrictive example in the appended drawings in which:

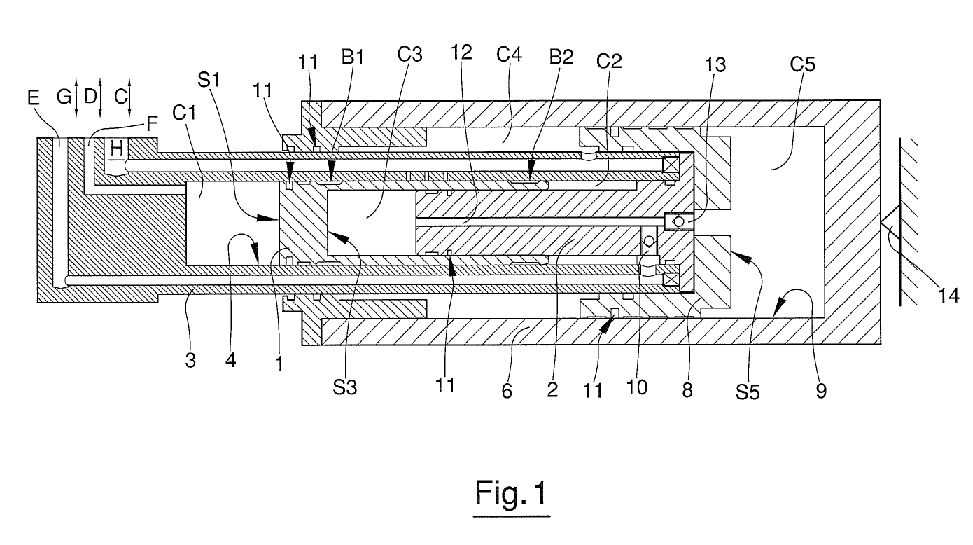

FIG. 1 illustrates a first preferred embodiment of the intensifier of the present invention in a diametrical cross section;

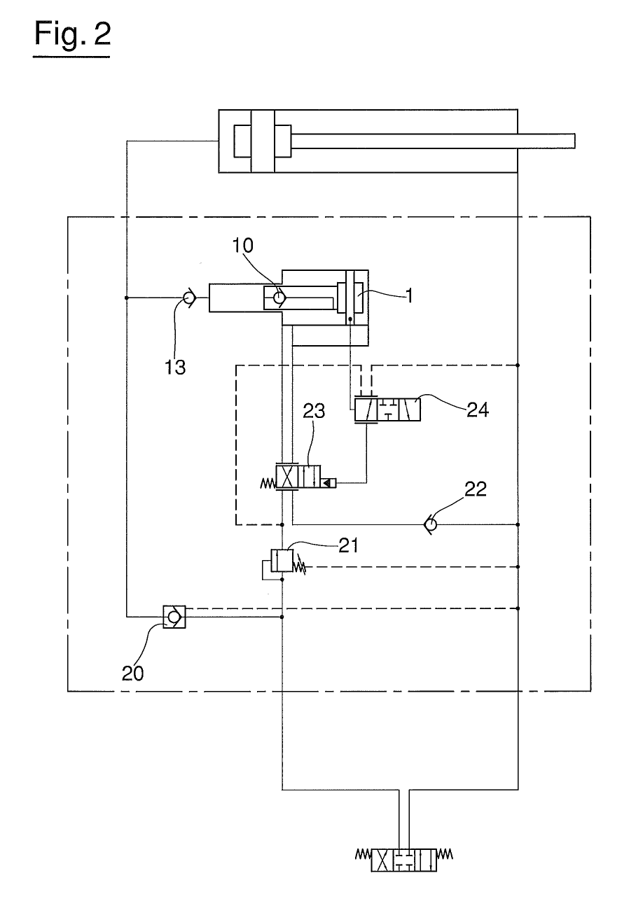

FIG. 2 illustrates one of the possible circuits suitable for actuating the device represented in FIG. 1;

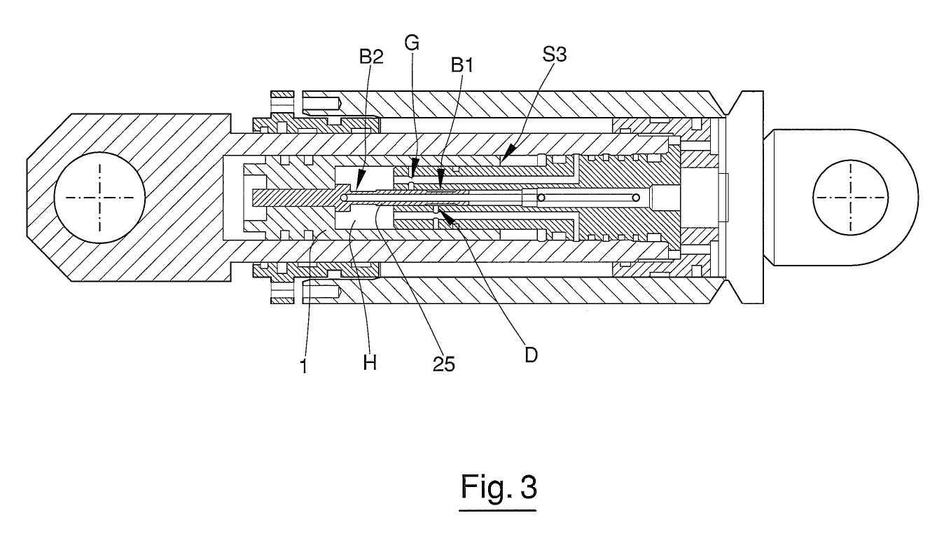

FIG. 3 shows a second embodiment in a cross section analogous to the one in FIG. 1;

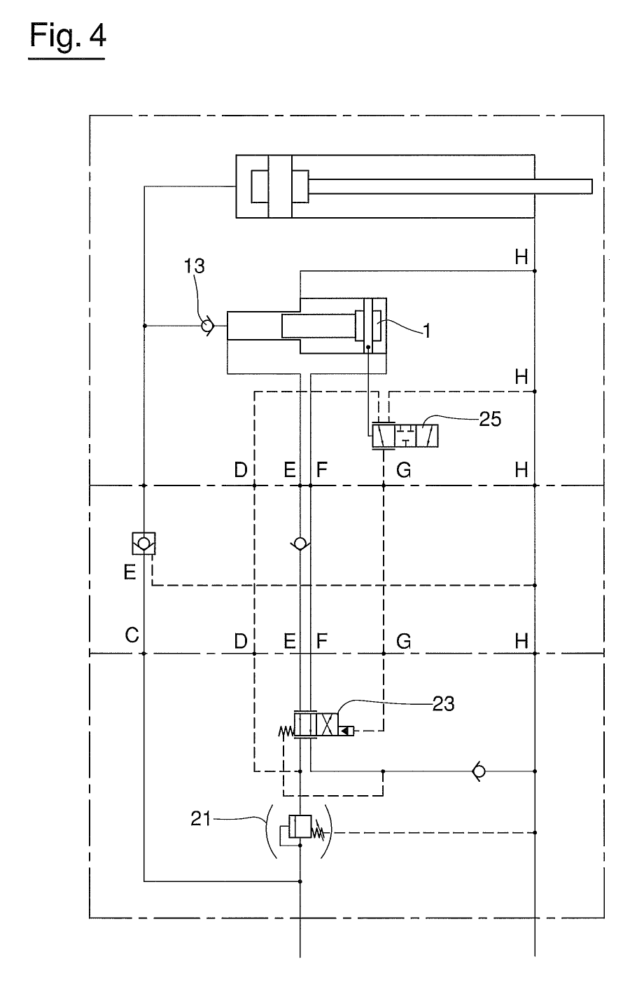

FIG. 4 shows a hydraulic diagram of the embodiment of FIG. 3;

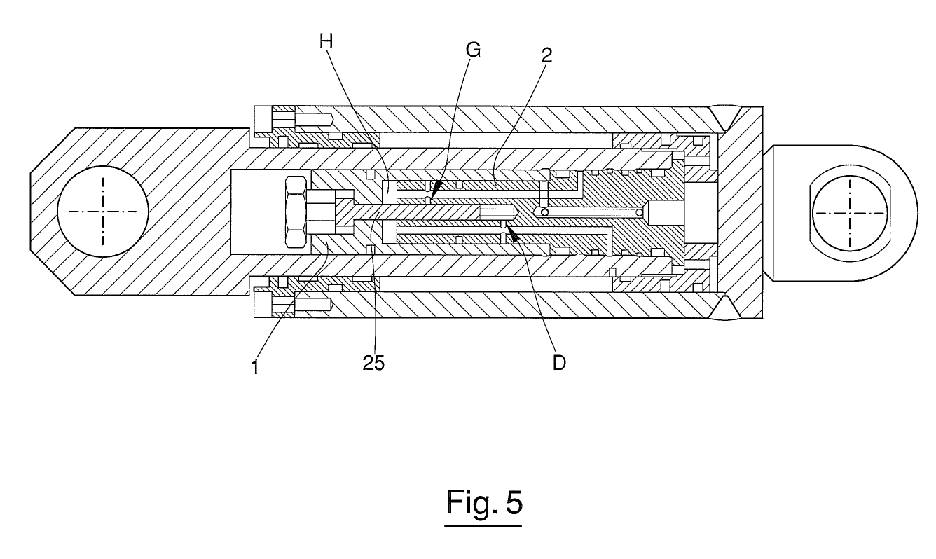

FIG. 5 shows a third embodiment in a cross section analogous to the one in FIG. 3;

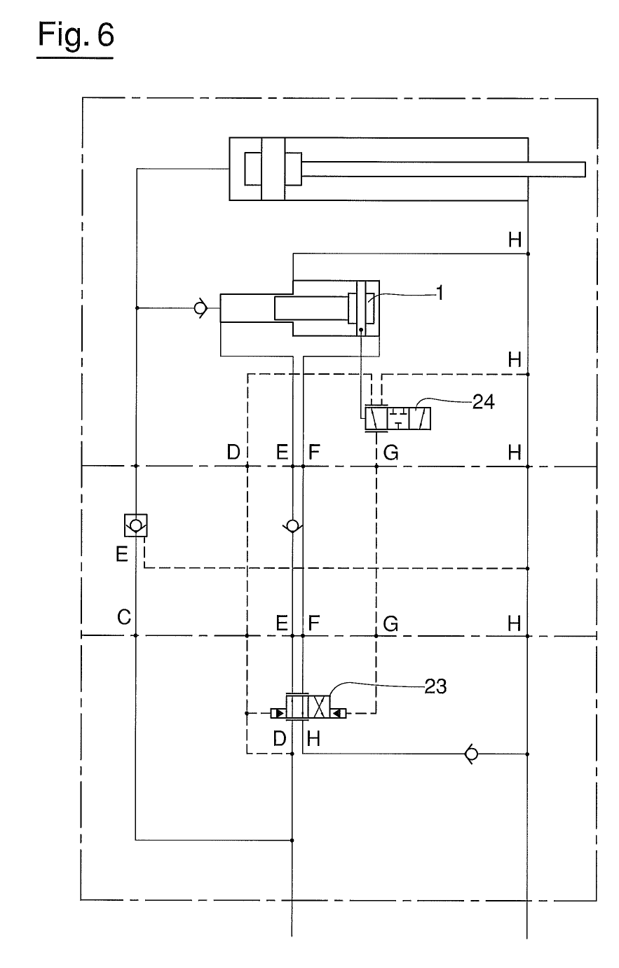

FIG. 6 shows a hydraulic diagram of the embodiment of FIG. 5.

In the different figures, the same alphanumerical references designate the same parts or elements. With reference to FIG. 1, 1 indicates the double-acting reciprocating piston or pressure multiplying piston which slides and is guided in the sliding seat or stem 2, which is integrally formed or added and solidly joined to the mobile body or stem 3, on the inside of which, in addition to the rod or sliding seat 2, there is a housing 4 within which the double-acting reciprocating piston or pressure multiplying piston 1 can slide reciprocally; the body 3, mobile element homologous to the stem, is closed on end and at the other end bears a piston 8, which prevents the reciprocating piston or pressure multiplying piston 1 from coming out and, by means of a gasket, a seal is realised on the internal part 9 of the liner 6. In other words, the components 1,6 and 3 have a circular cross section, are concentric and placed one inside the other, thus giving rise to two double-acting cylinders having particular characteristics.

As may be noted, from the configuration of the various components there are originated five pressure chambers C1,C2,C3,C4,C5, which are in communication with the outside by means of the conduits E,F,H,C,D,G; suitable gaskets 11 form the necessary seals.

In the stem 2 there is fashioned a hole 12 which connects the chambers C5 with C3 and a unidirectional valve 13 allows communication only from C3 toward C5. The conduits E,F,H,C,D,G are connected to the valves of the hydraulic circuit of FIG. 2.

The fixed part or liner 6 is connected, by means of known constraints 14, to the weight-bearing structure of the machine or equipment that uses the actuator, whereas the mobile part or body or mobile stem 3, which is the part that exerts the active force F on the resistant load, can be connected with suitable known means to the mechanical member which, during its movement, may meet resistances to be overcome.

It is true that by virtue of the principle of action and reaction, the functions of the fixed part (liner) and mobile part (stem) 3 are perfectly interchangeable with each other.

As will be apparent from the description provided of a preferred embodiment, the invention is not limited to the cited example, which has been presented solely as an illustrative example. It is understood that other steps, examples, compositions and operative procedures will present themselves spontaneously to a person skilled in the art following a careful reading of this disclosure, without them having to be considered outside the scope of the present invention; hence, for example:
it has been chosen that the chamber C3 amplifies the pressure while the chamber C2 resets the reciprocating piston or pressure multiplying piston 1 (i.e. makes it go back), but the functions can be switched over,
the same may be said for the unidirectional (or check) valves 13 and 10, which can be reciprocally connected 13 with C2 and 10 again with C2 C3 but in the opposite direction
the introduction of a linear position transducer and/or of presence, pressure or other detectors and a programmable electronic card, will allow the operation of the actuator to be automated in the case it is used to actuate presses, close die sets, etc.

The operation of the device according to the invention is the following:
let us suppose it is used for the operation of equipment installed on the arm of an excavator and intended to demolish reinforced concrete structures or to cut and demolish iron structures or profiles;
during the forward stroke the pressure multiplying piston 1 and the mobile body or stem 3 move together and the pressure multiplying piston 1 is “idle” because the sequence valve 21 is closed;
when the resistant force exceeds a certain value, the sequence valve 21 opens and sends fluid under pressure to C1 by means of the slide or spool valve 23; therefore, for the equilibrium of the pressure multiplying piston 1, the pressure in chamber C3 becomes that in chamber C1 multiplied by S1/S3 (where S1 is the surface of the pressure multiplying piston 1 and S3 is the inner surface again of the pressure multiplying piston 1 from the side of the sliding seat or rod 2); the fluid is then transferred from C3 into C5 by means of the unidirectional or check valve 13 without being able to return from C5 into C3;
the force is thus multiplied, because this same high pressure in C3 acts upon the active surface S5 of the pressure chamber C5;
however, when the pressure multiplying piston 1 has fully completed its stroke, the mobile body or stem 3 will have completed a shorter one according to the ratio S3/S5 and will have to move back;
in this position the shallow projection or pilot edge B1, carried by the pressure multiplying piston 1, places in communication the holes D and G which pilot the slide or spool valve 23 and invert it, causing the pressure multiplying piston 1 to move back while the mobile body or stem 3 remains in position thanks to the unidirectional valve 13 and the piloted check valve 20. When the shallow projection or pilot edge B2 places G and I in communication, the pressure multiplying piston 1 restarts for the subsequent pumping.

A possible variant embodiment is shown in FIG. 3, corresponding to the CETOP diagram of FIG. 4. The feedback positioning device identified with 24 in FIG. 2, which with reference to FIG. 1 had the pilot edges B1 and B2 formed as a piece on the pressure multiplying piston 1, can be realised by means of a “flute” or spool brought to the centre of the pressure multiplying piston, identified by 25 in FIG. 3.

The pressure multiplying chamber S3, which in FIG. 2 is the central one of the pressure multiplying piston 1, in the case of FIG. 3 is the outer annular one. The circuit of FIG. 2 can undergo three variants as per FIG. 4:

A) the spool 23 switches over the crossed and parallel configurations
B) the sequence valve 21 is not mounted
C) the check valve 10 of FIG. 2 is replaced by a discharge connection H.

With reference to FIG. 5, the flute or spool 25 is diametrically released from its constraint with the pressure multiplying piston 1 elsewhere called a booster; that is, a diametrical coupling play of a few tenths of a millimetre is created so that the flute or spool 25 can self-centre in the sliding seat 2, maintaining only an axial support constraint

To maintain said axial support, it is possible to conduct the pressure of the mouth D to the head of the flute or spool 25 in such a way that both the flute and the booster or pressure multiplying piston 1 are normally pushed back into the position of rear dead centre and the areas of positive covering between the flute and seat are of the maximum length possible to avoid leaks as much as possible.

With reference to FIG. 6 it is possible to realise the spool 23, which performs the function of feeding the booster or pressure multiplying piston 1 in turn piloted by the flute 25, with hydraulic instead of spring-controlled re-centring in order to improve the response thereof in terms of time and reliability.

The invention thus conceived is susceptible of numerous modifications and variants, all falling within the scope of the inventive concept; moreover, the details may be replaced with other technically equivalent ones.

In the practical implementation of the invention, the materials, shapes and dimensions can be any whatsoever according to need.

1. An intensifier of hydraulic power with reset with maintenance of the reached position and of the thrust force obtained during each phase of reset, which includes a fixed part homologous to the liner of a normal double-acting hydraulic cylinder, a mobile part homologous to the stem, a double-acting mobile piston added inside the stem which can move reciprocally and which permits the multiplication of the force by feedback positioning through a pure proportional servo-control, hydraulic circuit, said fixed part having the double function of liner for the piston and of slide for the mobile part homologous to the stem, the said mobile part having the double function of stem and slide for the said piston, the said piston being movable reciprocally by the said hydraulic circuit formed by suitable valves and relative distributor, the hydraulic circuit having the function of actuating individual components of the intensifier based on user needs, means for fixing the actuator to a structure and means for connecting the mobile part to what has to be actuated, the whole formed and disposed in such a way as to configure a double-acting cylinder plus a single-acting one concentric to each other, containing a double-acting concentric piston, whose reciprocal movement is independent and at each cycle (forward and back stroke) produces an increase in force and an intermittent advancing of the said mobile part when it has to overcome an obstacle; said intensifier being characterized in that as the said mobile part, mobile body or stem (3) advances without meeting obstacles or resistances, the reciprocating piston or pressure multiplying piston (1) also advances with it at the same rate because a conduit (C) is suitably fed while a sequence valve (21) is closed and a conduit (F) is discharging; when it meets a resistance or an obstacle the sequence valve (21) automatically opens and pressure in a compression chamber (C3) increases based on the ratio of surface S1 and S3, wherein surface S1 is the surface of the pressure multiplying piston (1) and surface S3 is the surface of the said piston on the stem side (2).

2. (canceled)

3. The intensifier as recited in claim 1, wherein by acting upon said distributor it is possible to move said piston 1 reciprocally and cause said mobile part 3 to advance with intermittent motion maintaining the maximum thrust constant without the mobile part 3 moving back from the previously reached position.

4. An intensifier as recited in claim 1, wherein the mentioned components concentric and placed one inside the other configure two hydraulic cylinders placed one inside the other which give rise to five pressure chambers (C1,C2,C3,C4,C5) which are connected by six conduits (E,F,H,G,D,C) to valves controllable by an operator by a distributor, with which the operator governs the intensifier according to operational needs.

5. The intensifier as recited in claim 1, wherein the compression chambers (C5,C3) are unidirectionally connected by a conduit or hole 12 made in the rod or sliding seat 2, into which a unidirectional valve 13 is inserted, regardless of its design.

6. (canceled)

7. The intensifier as recited in claim 1, wherein the feedback positioning and reversing device comprising the pilot edges (B1,B2), the mouths (D,G,H) can be replaced by other known means which perform the same functions.
